(19) United States
(12) Patent Application Publication
(10) Pub. No.: US 2025/0313973 A1
(43) Pub. Date: Oct. 9, 2025

(54) TIO2 PHOTOANODES DOPED WITH Zr-Fe2O3

(71) Applicant: KING SAUD UNIVERSITY, RIYADH (SA)

(72) Inventors: Prabhakarn ARUNACHALAM, RIYADH (SA); Maged N SHADDAD, RIYADH (SA); Mabrook S AMER, RIYADH (SA); Abdullah M. AL-MAYOUF, RIYADH (SA)

(21) Appl. No.: 18/629,209

(22) Filed: Apr. 8, 2024

(51) Int. Cl. C25B 11/091; C25B 1/04; C25B 9/50; C25B 11/052; C25B 11/063

(52) U.S. Cl. CPC C25B 11/091; C25B 1/04; C25B 9/50; C25B 11/052; C25B 11/063

(57) ABSTRACT

A titanium substrate includes TiO₂ nanotubes (TNTs) uniformly distributed thereon, wherein the TiO₂ nanotubes are doped with ZrO₂ and Fe₂O₃. The presence of both ZrO₂ and Fe₂O₃ on TNTs arrays achieves synergistic results to provide improved energy conversion efficiency for photoelectrochemical (PEC) water oxidation systems.

### BACKGROUND

### 1. Field

The present disclosure relates to titanium dioxide (TiO₂) photoanodes and, particularly, to titanium dioxide (TiO₂) photoanodes doped with ZrO₂ particles and Fe₂O₃ particles for photoelectrochemical (PEC) water splitting.

### 2. Description of the Related Art

Photocatalysis involves the use of light to overcome thermodynamic and kinetic reaction barriers in chemical reactions. The energy change associated with a given chemical reaction may be described by Gibbs Free Energy, G. In the case where the AG for a reaction is positive, energy must be added to the system to accomplish the desired reaction. This energy may be provided in the form of light, and photocatalysts may be used to facilitate the conversion of photons into stored chemical energy.

A non-limiting application of this concept is the capture, conversion, and storage of solar energy through the rearrangement of chemical bonds to make fuel. Solar energy can be a carbon-neutral energy source of sufficient scale to meet future global energy demand. Thus, the conversion of sunlight into chemical fuels offers a viable mechanism for renewable energy storage and utilization. A typical photocatalytic system employs at least one photoactive composition, which, upon exposure to sunlight, produces electron/hole pairs that may be used to drive chemical reactions that store energy. In this context, several energy storing reactions are particularly suitable, including the conversion of water to hydrogen and oxygen (i.e., “water splitting”),

Out of concern for natural resource depletion and ecological disputes, solar-assisted water electrolysis systems to produce hydrogen and oxygen have arisen as probable candidates to boost the advancement of clean systems for creating energy. For example, the US Department of Energy has assessed the hydrogen threshold cost in the range of <$4/Kg for forthcoming solar hydrogen generation. Thus, photoelectrochemical (PEC) water splitting is a favorable method for clean hydrogen generation.

In past decades, extensive research efforts were carried out to achieve sustainable and efficient n-type semiconductors as photoelectrodes. Of the numerous metal oxide semiconductors that have been widely explored (e.g., TiO₂, ZnO, SrTiO₃, Fe₂O₃, and WO₃), TiO₂ is considered a promising candidate due to its acceptable band-edge positions, high optical stability, and high chemical stability. Despite this, the photoelectricity conversion efficiency of TiO₂ for solar hydrogen production still presents a challenge. Moreover, it has a larger bandgap (<3.2 eV) confining its optical absorption within the ultraviolet region of the electromagnetic spectrum, leaving 48% of visible light excitons. More importantly, electron transitions from the valence to the conduction band can be restricted.

Various tactics that have been developed to enhance the photocatalytic features of TiO₂ include improving the active specific surface area, decreasing the wider bandgap value, and boosting the photogenerated charge separation and electron transfer performances. Amongst the different TiO₂ structures, TiO₂ nanotubes (TNTs) tend to have an optimized optical path length and charge diffusion length, thereby permitting photons and reactants to diffuse alongside the whole tubular depth. In recent years, TNTs arrays fabricated by an electrochemical anodization method have been established to be an effective photoanode for photoelectrochemical (PEC) water-oxidation reactions.

A main benefit of TNTs arrays is their morphological features, which can accommodate co-catalytic materials within the nanotube walls. As such, higher spatial regulation of the catalytic materials can be reached beside the nanotube (NT) walls. Dual-step electrochemical anodization which comprises a first anodization for the growth of TNTs and their successive elimination and a second anodization to produce TNTs arrays from a similar substrate, is a substitute for developing highly ordered TNTs arrays. Further, under appropriate synthetic conditions, distinct hierarchical top-layer/bottom-tube TNTs can be obtained; thereby retaining considerably better features in dye-sensitized solar cells than those obtained from single-step anodization. However, with appropriate morphological features, it is believed that the topmost film can work as a photonic crystal to promote the absorption features of the hierarchical TNTs.

Thus, photoanode films solving the aforementioned problems are desired.

### SUMMARY

The present subject matter relates to a photoanode, including a titanium substrate having TiO₂ nanotubes (TNTs) uniformly distributed thereon, wherein the TiO₂ nanotubes are doped with ZrO₂ and Fe₂O₃. The presence of both ZrO₂ and Fe₂O₃ on or in TNTs arrays achieves synergistic results to provide improved energy conversion efficiency for photoelectrochemical (PEC) water oxidation systems. For example, the photoanodes as described herein can achieve a photoconversion efficiency of about 1.2 mA/cm².

According to an embodiment, a photoanode as described herein can include a titanium substrate having TiO₂ nanotubes (TNTs) uniformly distributed thereon. In an embodiment, the TiO₂ nanotubes can have an inner diameter ranging from about 42 nm to about 52 nm and can be doped with ZrO₂ and Fe₂O₃.

These and other features of the present subject matter will become readily apparent upon further review of the following specification.

### BRIEF DESCRIPTION OF THE DRAWINGS

FIGS. 1A-1B are (1A) UV-vis absorption spectra and (1B) corresponding Tauc plots for direct optical transitions showing the relationship between (αhv)² and E (eV) for parent TNTs (i), α-Fe₂O₃ (ii), TNTs/ZrO₂ (iii), TNTs/Fe₂O₃ (iv), and TNTs/Zr—Fe₂O₃ (v), with bandgaps of 3.2, 2.2, 3.1, 2.02 and 1.98 eV, respectively.

FIGS. 2A-2C are graphs showing XRD patterns of (2A) bare TNTs, TNTs-ZrO₂, TNTs-Fe₂O₃, and TNTs-Zr—Fe₂O₃ electrodes (no diffraction peaks of Zr were observed); (2B) XRD patterns of bare Ti foil, Ti—Fe₂O₃, and Ti—Zr—Fe₂O₃ electrodes; and (2C) Raman spectra of pure TNTs, TNTs/Fe₂O₃, and TNTs/Zr—Fe—O electrodes.

FIGS. 3A-3F are FE-SEM photographs of (3A) TNTs; (3B) TNTs/ZrO₂; (3C) TNTs/Fe₂O₃ under different magnifications; and (3D, 3E, 3F) TNTs/Zr—Fe—O arrays under different magnifications.

FIG. 4 is an energy dispersive spectroscopy (EDS) result of the TNTs/Zr—Fe—O photoanodes prepared by a two-step anodization process.

FIGS. 5A, 5B, 5C, 5D are HR-TEM images showing the homogenous and reproducibility of the two-step electrochemically anodized TNTs/Zr—Fe—O films at various magnifications of TNTs/Zr—Fe—O electrodes.

FIGS. 6A-6E show surface features of modified TNTs in (6A) a comparative XPS survey of TNTs, TNTs/ZrO₂, and TNTs/Zr—Fe₂O₃, high-resolution XPS spectra results of Ti 2p; (6B) Ols spectra; (6C) XPS results on analyzed samples corresponding to (6D) Zr 3d spectra of TNTs/ZrO₂, TNTs/Zr—Fe₂O₃, and (6E) Fe 2p orbitals of TNTs/Zr—Fe₂O₃ samples.

FIGS. 7A-7F show photoelectrochemical measurements of photoanodes where (7A) photocurrents were acquired at 1.23 VRHE for varied Fe deposition charges (mC·cm⁻² “blue symbols”) and different Zr/Fe concentration (mole % “red symbols”) additions in the 1.0 M NaOH; (7B) j-V curves of the synthesized electrodes of bare TNTs, TNTs/ZrO₂, TNTs/Fe₂O₃, and TNTs/Zr—Fe₂O₃ electrodes obtained under constant illumination at 100 mWcm⁻²; (7C) LSV characteristics of photoanodes obtained under chopped illuminations; (7D) curves of AJ at 1.23 VRHE vs. sweep rates; LSV plots of the acquired electrode; (7E) variations in the photocurrent response for all of the acquired films in 0.1 M PBS (pH 7.5) at 0.6 and 1.23 VRHE; and (7F) estimated ABPE efficiency.

FIGS. 8A-8D are LSV curves of TNTs/Zr—Fe—O under constant (8A) and chopped irradiation in (8B) 0.1 M PBS and 0.1 M PBS+1 M Na₂SO₃, correspondingly; (8C) plots of η_{surface} vs. potential acquired for TNTs and TNTs/Zr—Fe—O films; and (8D) the TNTs/Zr—Fe—O based photocurrent responses for 0, 0.2, 0.4, 0.6, 0.8, and 1.0 mM H₂O₂ (from top to bottom).

FIGS. 9A-9B are graphs showing (9A) oxygen evolution concentration under continuous illumination conditions at the potential of 0.6 V vs. RHE in 0.1 M PBS at (pH 7.5) for TNTs/Zr—Fe—O films; and (9B) equivalent chronoamperometric measurements for water electrolysis at 0.6 V vs. RHE during irradiation by visible light (cutoff filter λ>420 nm).

FIGS. 10(A)-10(C) are graphs showing (10A) J-t curve for long-term photostability of bare TNTs, and TNTs/Zr—Fe₂O₃ photoanode at 0.6 V vs. RHE for ˜11 h under AM 1.5 G illumination; and (10B) an SEM image of the TNTs/Zr—Fe₂O₃ electrode taken after durability test of 12 h in 0.1 M PBS (pH 7.5); and (10C) X-ray diffraction patterns of TNTs/Zr—Fe₂O₃ films before (solid) and after (dotted) 12 hours.

FIGS. 11A-11B show (11A) IPCE spectra obtained on the synthesized electrodes (bare TNTs), TNTs/ZrO₂, TNTs/Fe₂O₃, and TNTs/Zr—Fe₂O₃ electrodes at 1.23 V vs RHE in 1 M NaOH; and (11B) APCE spectra acquired from IPCE and absorbance analysis.

FIGS. 12A-12B show (12A) Nyquist plots under 100 mW·cm⁻² illuminations of bare TNTs, TNTs/ZrO₂, TNTs/Fe₂O₃, and TNTs/Zr—Fe—O electrodes at 1.23 V_{RHE} with a frequency range between 100,000 to 0.05 Hz and the inset of figures displays the equivalent circuit and its enlarged view; and (12B) Mott-Schottky curves of the capacitance of TNTs, TNTs/Fe₂O₃, TNTs/ZrO₂, and TNTs/Zr—Fe—O photoanodes in the dark at a stable frequency of 50 Hz.

FIG. 13 is a diagram showing the TNTs/Zr—Fe—O electrode and its energy levels under illumination for the electrode and electrolyte interface.

Similar reference characters denote corresponding features consistently throughout the attached drawings.

### DETAILED DESCRIPTION OF THE PREFERRED EMBODIMENTS

The following definitions are provided for the purpose of understanding the present subject matter and for construing the appended patent claims.

### Definitions

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

It will be understood by those skilled in the art with respect to any chemical group containing one or more substituents that such groups are not intended to introduce any substitution or substitution patterns that are sterically impractical and/or physically non-feasible.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

The present subject matter relates to a photoanode, including a titanium substrate having TiO₂ nanotubes (TNTs) uniformly distributed thereon, wherein the TiO₂ nanotubes are doped with ZrO₂ and Fe₂O₃. The photoanode can be used for energy conversion in photoelectrochemical (PEC) water oxidation systems.

As described herein, the presence of co-catalysts, ZrO₂ and Fe₂O₃, on TNTs arrays can achieve synergistic results to provide improved energy conversion efficiency for photoelectrochemical (PEC) water oxidation systems. For example, the photoanode can have a photoconversion efficiency of about 1.2 mA/cm². As described herein, the recombination rate of photoinduced carriers can be reduced due to the presence of the co-catalysts, which can act as electron and hole sinks due to their suitable energy level positions.

In an embodiment, BiVO₄ electrodes with the regulated addition of Zr and Fe precursors through electrochemical deposition can attain a five-fold enrichment for solar-assisted water-oxidation processes. Further, ZrO₂ can be successfully applied to passivate the BiVO₄ surface traps in solar-assisted water oxidation schemes. As described herein, however, the synergistic amalgamation of ZrO₂ and Fe₂O₃ on TNTs arrays can achieve a further boost of energy conversion efficiency for PEC water oxidation systems.

According to an embodiment, a photoanode as described herein can include a titanium substrate having TiO₂ nanotubes (TNTs) uniformly distributed thereon, wherein the TiO₂ nanotubes can be doped with ZrO₂ and Fe₂O₃ and can have an inner diameter ranging from about 42 nm to about 52 nm. In an embodiment, the TiO₂ nanotubes can have a wall thickness ranging from about 32 nm to about 46 nm. According to an embodiment, the TiO₂ nanotube can have a tube length of about 1 m to about 5 m, e.g., about 1 m.

In another embodiment, a method of making a photoanode for photoelectrochemical (PEC) water oxidation can include providing titanium nanotube arrays on a titanium substrate and doping the titanium nanotubes with zirconium oxide (ZrO₂) and iron oxide (FeO₃) films using electrochemical deposition. In an embodiment, the titanium nanotube arrays can be provided on the titanium substrate by subjecting the titanium substrate to electrochemical anodization. In one embodiment, the titanium substrate can be subjected to two rounds of electrochemical anodization.

In an embodiment, the electrochemical deposition for doping the titanium nanotubes with zirconium oxide (ZrO₂) and iron oxide (FeO₃) films can include using an electroplating solution including ZrCl₂O·8H₂O and FeCl₂ for doping the titanium nanotubes. In one embodiment, the electroplating solution can contain about 20 mM FeCl₂ and different amounts of ZrCl₂O·8H₂O in a Zr/Fe molar ratio ranging from about 1.5% to about 6.5%, e.g., about 1.5%, about 2.5%, about 3.5%, about 4.5%, about 5.5%, or about 6.5%, e.g., about 3.5%. Accordingly, improved PEC water oxidation kinetics of TNTs arrays can be achieved by the successive introduction of Zr and Fe precursors. As described herein, the electrodeposition can be completely reproducible and easy to apply to larger area conductive films.

In the photoanode films described herein, Fe₂O₃ can act as an oxygen evolution reaction (OER) catalyst to boost OER kinetics, while ZrO₂ can offers traps for charge carriers, favoring the spatial photoinduced separation of electron-hole pairs TNTs arrays. As such, an optimum photocurrent response and photoconversion efficiency of 1.2 mA/cm² can be achieved by the Zr-doped α-Fe₂O₃/TNTs photoanode described herein. Additionally, incident photon to current conversion efficiency (IPCE) and absorbed photon to current conversion efficiency (APCE) values achieved by the Zr-doped α-Fe₂O₃/TNTs photoanode can be about 1.23 VRHE.

The present teachings are illustrated by the following examples.

### EXAMPLES

### Example 1

### Preparation of TNTs Photoelectrodes

TNTs arrays were acquired by dual-step anodization of Ti foil (>99.5% purity, Alfa Aesar) under natural circumstances. Initially, a thick Ti foil (0.25 mm) was ultrasonically washed with acetone and deionized (DI) water in an ultrasonic medium for 20 minutes Afterward, the titanium foil was exposed to electrochemical anodization for 30 minutes in a 2-electrode electrochemical system with a Pt foil as the counter electrode. A continuous voltage of 60 V was applied for the electrochemical anodization, and the electrolyte employed was 0.12 M ammonium fluoride (Sigma-Aldrich) in a 5:100 (w/w) mixture of DI water and ethylene glycol (EG). Subsequently, the Ti substrate was removed and cleaned with DI water for the subsequent round of electrochemical anodization under similar situations except that the duration period was 180 minutes. Lastly, the acquired films were then washed with DI water numerous times and calcined in air at 450° C. for 120 minutes with a ramping level of 2° C./minutes to acquire crystalline TNTs over the Ti foil.

### Example 2

Fabrication of TNTs/Fe₂O₃ Films

TNTs/Fe₂O₃ electrodes were prepared through electrochemical deposition using an electrodeposition bath involving 20 mM FeCl₂ in ethylene glycol (EG). The electrodeposition was carried out in a 3-electrode system consisting of a TNTs working electrode. The electrochemical deposition was executed at −2.0 V vs. Ag/AgCl, and an optimal process of this step was executed by tuning the total deposition charge from 1 to 10 mC/cm². Further, the electrode film was then annealed at 450° C. for 1 hour in still air. An α-Fe₂O₃/FTO photoelectrode was also fabricated using the same procedure.

### Example 3

### Fabrication of TNTs/Zr—Fe—O Electrodes

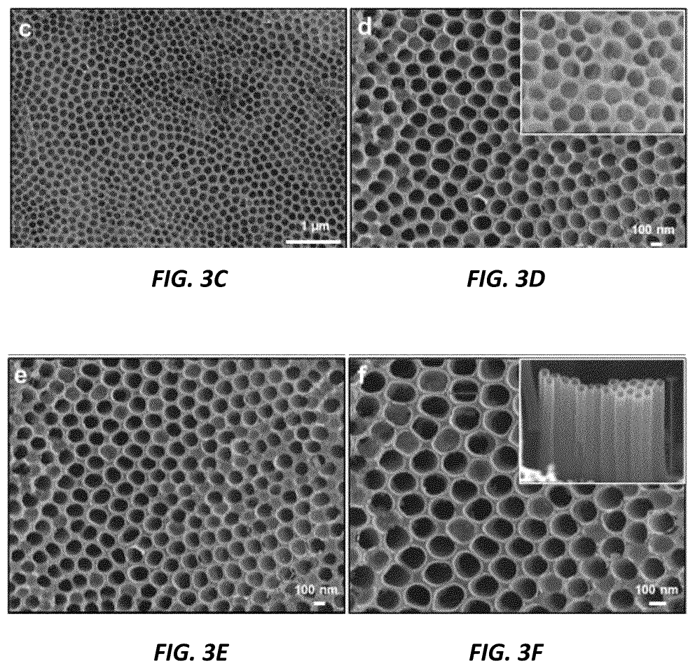

An ethylene (EG) solution containing 20 mM FeCl₂ (Sigma-Aldrich) and different amounts of ZrCl₂O·8H₂O (1.5, 2.5, 3.5, 4.5, 5.5, and 6.5% Zr/Fe molar ratio) was prepared as the electroplating solution. The deposition was executed by passing 5 mC/cm² at E=−2 V vs. Ag/AgCl. Subsequently, the film was annealed at 450° C. for 1 hour in the air (ramp rate=2° C./min). The optimized molar ratio (for the best-optimized photocurrent response from the PEC system) was assessed to be 3.5% (FIG. 3B). A TNTs/ZrO₂ photoelectrode was prepared for comparison by following the same procedure without Fe.

### Example 4

### PEC Performance Measurements

PEC examinations of the acquired films were executed through cyclic voltammetry in a 0.1 M PBS. All PEC studies were executed via the AutoLab potentiostat PGSTAT30 system. The classical electrochemical system was comprised of the working electrode (FTO), an Ag/AgCl (3M KCl) reference electrode, and a Pt wire as a counter electrode. All the PEC analyses were executed both in the dark and under simulated sunlight irradiations (300 W Xe lamp, 100 mW/cm²). A photocurrent spectroscopy system (Instytut Fotonowy) armed with a 150 W Xenon lamp and a monochromator was applied for the incident photon to current conversion efficiency (IPCE) analysis with the applied potential of 1.23 V_{RHE}. The IPCE values were assessed through eqn. 1:

$$IPCE \% = \frac{{I}_{ph} ( A )}{P ( W )} \times \frac{1239.8}{λ ( nm )} \times 100 \qquad ( 1 )$$

where Iₚₕ is the photocurrent density, P is the light power density, and λ is the wavelength of the light.

### Example 5

### Results and Discussion

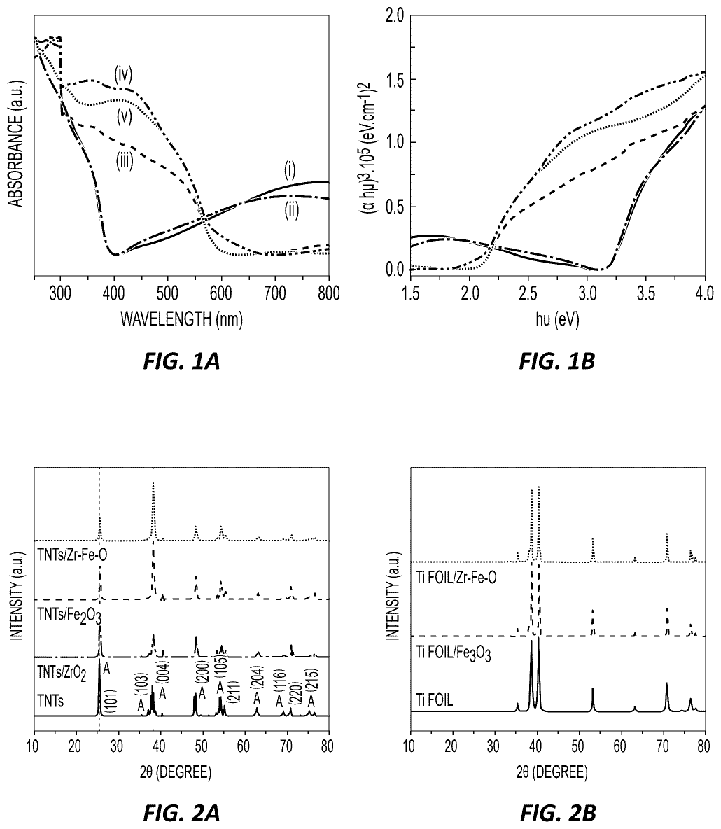

To determine the effect of both additives (Zr and Fe) on the PEC features of the films, comprehensive morphological and optical examinations were executed. UV-vis diffuse reflectance spectroscopy determined the optical band gap and absorption of the acquired electrodes, as displayed in FIG. 1A. The electrodeposition of Zr—Fe films resulted in promoted optical features of the TNTs electrode in the visible-light region due to their electron transition at the band edges of the anatases-scheelite phase of TNTs. A combination of TNTs/Zr—Fe—O films displayed the best light absorption, demonstrating that Zr and Fe₂O₃ act synergistically to enhance the optical density. FIG. 1B shows the relationship amongst (αhv)^{1/12} and E (eV) for α-Fe₂O₃, TNTs, TNTs/ZrO₂, TNTs/Fe₂O₃, and TNTs/Zr—Fe—O, with bandgaps of 2.2, 3.2, 2.02, and 1.98 eV, respectively. As shown above, the thin layer covering the Zr—Fe₂O₃ particles can induce higher absorption of visible light excitons. However, whether the promoted absorption actually corresponds to an enhanced photocurrent density is difficult to prove with absorption data alone.

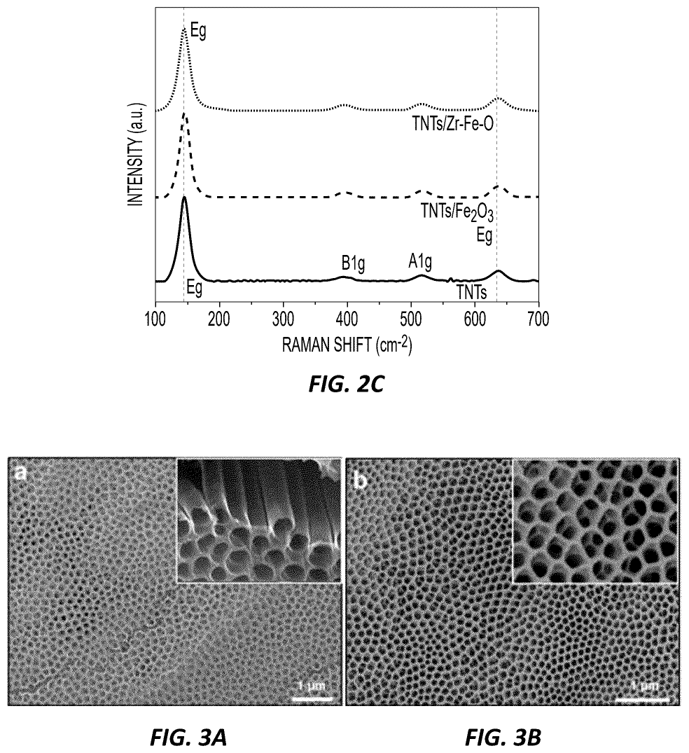

Structural features of the obtained electrode materials were carried out through XRD (FIGS. 2A and 2B). All the fabricated TNTs electrodes annealed in still air revealed the pure anatase phase (JCPDS 21-1272) deprived of any other trace secondary phases. Also, the diffraction peak related to the (101) planes lead in all of the fabricated bare TNTs, TNTs/ZrO₂, TNTs/Fe₂O₃, and TNTs/Zr—Fe₂O₃ samples, as stated for other TNTs. Further, owing to the low-level loading quantity of Zr incorporation, the observed peak shifts in diffractograms are not straightforward. Furthermore, Raman spectroscopy has been introduced for detecting the phase purity and surface composition of the obtained materials. The Raman spectroscopic examination of bare TNTs, TNTs/Fe₂O₃, TNTs/Zr—Fe—O films is displayed in FIG. 2C. It is demonstrated that the anatase phase controls the crystalline nature of the bare and Zr—Fe—O-loaded photoanodes. Anatase has six Raman-active vibrational modes (1A_{1g}+²B_{1g}+3E_{g}). The B_{1g}, A_{1g}, and E_{g} reflections, correspondingly, at 395 cm⁻¹, 518 cm⁻¹, and 637 cm⁻¹ all approve the anatase features of the TNTs. Also, after Zr—Fe—O incorporation over the TNTs, no peaks associated with ZrO₂ or Fe₂O₃ nanoparticles were recognized, possibly because of the fairly lower concentration of Zr—Fe—O loading over the TNTs and its weak Raman scattering. Lastly, it is clearly demonstrated that the Zr—Fe—O loading does not significantly modify the crystalline nature of TNTs.

Field emission scanning microscopy (FE-SEM) was employed to explore the morphological features of TNTs/ZrO₂ with and without the optimal Fe₂O₃ introduction (FIGS. 3A-3F). FIG. 3A displays the top and lateral outlook of the TNTs prepared after the second anodization. It was observed that the uniform TNTs are vertically aligned over the surface of the Ti foil with a tube length of around 1 m. Moreover, the obtained TNTs nanotubes were highly dense and uniformly distributed throughout the titanium substrate, as shown in FIG. 3A. The inner diameter and wall thicknesses were around 42-52 nm and 32-46 nm, correspondingly.

The optimal ZrO₂ films above TNT films obtained via the electrodeposition method and the FE-SEM images are displayed in FIG. 3B. Notable variations in the TNT surface morphological features were seen after loading with ZrO₂, where the ZrO₂ particles were homogeneously distributed over the surface of TNTs, withholding the NTs morphology (FIG. 3B).

FIGS. 3C-3D show the SEM results after decorating Fe₂O₃ particles over TNTs using the Fe electro-deposition process. As seen in FIGS. 3C-3D, TNTs surfaces are homogeneously covered with Fe₂O₃ nanoparticles.

FIGS. 3E-3F present a top view and lateral micrograph of the TNTs/Zr—Fe—O composite film. As seen, the TNTs array was well-ordered, and the NTs wall thickness and diameter did not vary after introducing Fe₂O₃ through the TNTs. On the other hand, after adding Fe₂O₃, some TNTs were distributed with Fe₂O₃ particles distinctly deposited on the surface of TNTs films (FIG. 3F). This can significantly enrich the light scattering effects at the surface of TNTs, clarifying the improved sub-bandgap absorption spectrum.

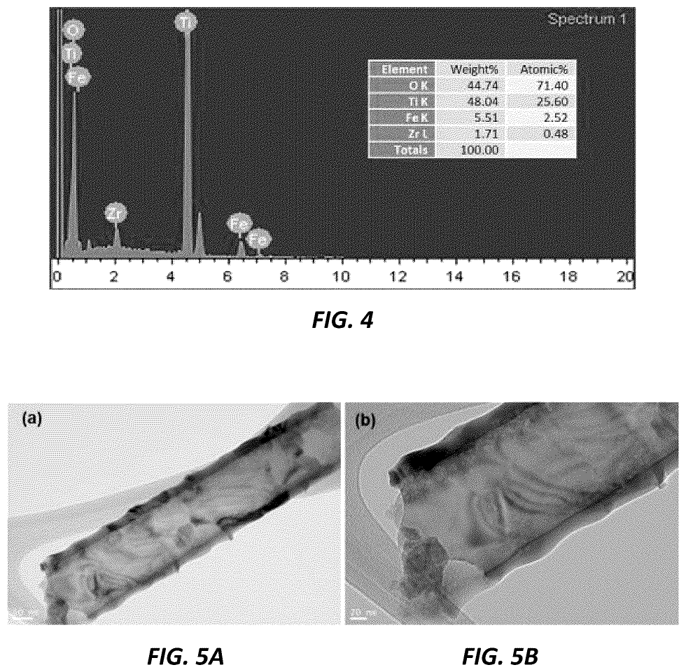

According to the EDS spectrum of the TNT/Zr—Fe—O in FIG. 4, in which Ti, O, Zr, and Fe peaks are detected, effective incorporation of the Fe₂O₃/ZrO₂ layer over TNTs was achieved.

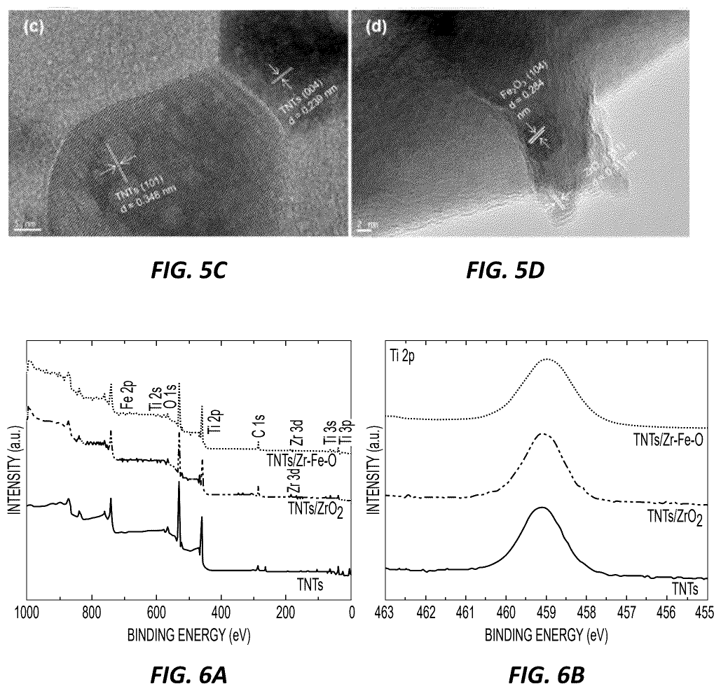

FIG. 5 displays HR-TEM photographs of the TNT/Zr—Fe—O films. The TEM photographs shown in FIGS. 5A and 5B indicate the homogeneity and alignment of the NTs' morphological features in the TNT/Zr—Fe—O films. Also, the TNTs films were vertically aligned, highly ordered structures, with an external diameter of 175±2 nm and a 31±2 nm wall thickness. Notably, the distinct lattice fringes of 0.348 nm seen in the TEM images in FIG. 5C match with the (101) plane of anatase phase of TiO₂, signifying the anatase natures of the TNTs. It was further observed that the TNTs/Zr—Fe—O electrodes included high crystalline particles (6-10 nm), with an interplanar distance of 0.31 nm (FIG. 5D), matching with the (111) reflection of monoclinic ZrO₂ (JCPDS card No. 1309-37-1). EDS confirmed the existence of Fe and Zr in these NTs (FIG. 4), specifying that although Zr might substitute Ti in the anatase-TNTs lattice, as shown by the XRD pattern, a substantial fraction of Zr existed in monoclinic-ZrO₂ particles over TNTs surfaces.

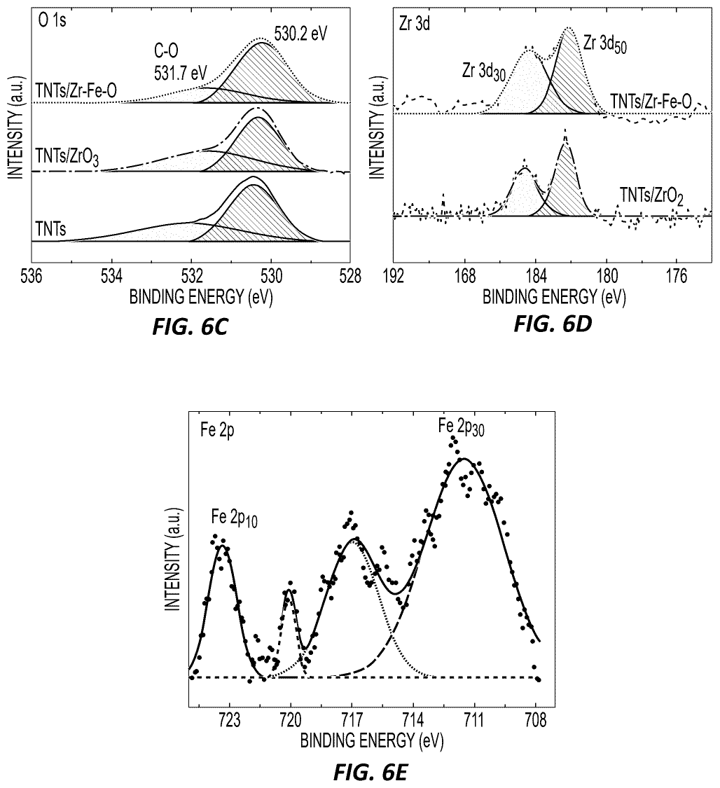

XPS analyses were performed to explore the surface feature of acquired electrodes before and after Zr—Fe₂O₃ decoration as well as the valence state of the surface of the electrodeposited TNTs samples. As noted in the survey XPS spectrum (FIG. 6A), the TNTs/Zr—Fe₂O₃ composite comprised Ti, O, Zr, and Fe, compared with the TNTs and TNTs/ZrO₂ samples. As XPS is a surface-sensitive method, it clearly validates inimitably conformal incorporation of Zr—Fe₂O₃ on the TNTs samples.

FIGS. 6B-6E display the XPS spectra for the Ti 2p, O 1 s, Zr 3d, and Fe 2p regions for the Zr—Fe₂O₃ deposited sample. For all of the photoanodes, the peaks related to Ti 2p_{3/2}, positioned at 458 eV, correspondingly, confirm the 4⁺ state of Ti connected with TiO₂ (FIG. 6B).

FIG. 6C displays the O is high-resolution XPS spectrum of Zr—Fe₂O₃ incorporated TNTs, which can be separated into two signals. Notably, the higher signal at 520.2 eV is credited to O²⁻ in the TiO₂ lattice, and the lower signal at 531.7 eV is credited to the surface hydroxyl group. Also, the presence of Zr over the fabricated films is verified by the fact that two signals positioned at 184.4 (Zr 3d_{3/2}) and 182 eV (Zr 3d_{5/2}), validating the 4⁺ state distinctive of ZrO₂ (FIG. 6D). Quantitatively, the definite quantity of Zr was assessed as >0.3 at % for all of the Zr—Fe₂O₃/TNT electrodes, which is at the limit of the detection of the analysis. Also, it was observed that Zr was bonded to oxygen in the nature of 4+ state, supporting the partial replacement of Ti⁴⁺ by Zr⁴⁺ ions. Undeniably, the surface replacement of Zr⁴⁺ by Ti⁴⁺ is owed to its ionic radii (0.72 and 0.61 Å, correspondingly). As anticipated, Fe signals were observed for the fabricated Zr—Fe₂O₃/TNT electrodes. Also, the acquired signals positioned at 711.5 eV (Fe₂p_{3/2}) and 723.5 eV (Fe2p_{1/2}) specify the existence of α-Fe₂O₃ and are concordant with the data described in the reports for the α-Fe₂O₃ phase, accounting for the binding energy parameters of Fe2p_{3/2} and Fe2p_{1/2}. Consequently, the Fe element might occur in the nature of Fe³⁺ and Ti—O—Fe bonds in the lattices.

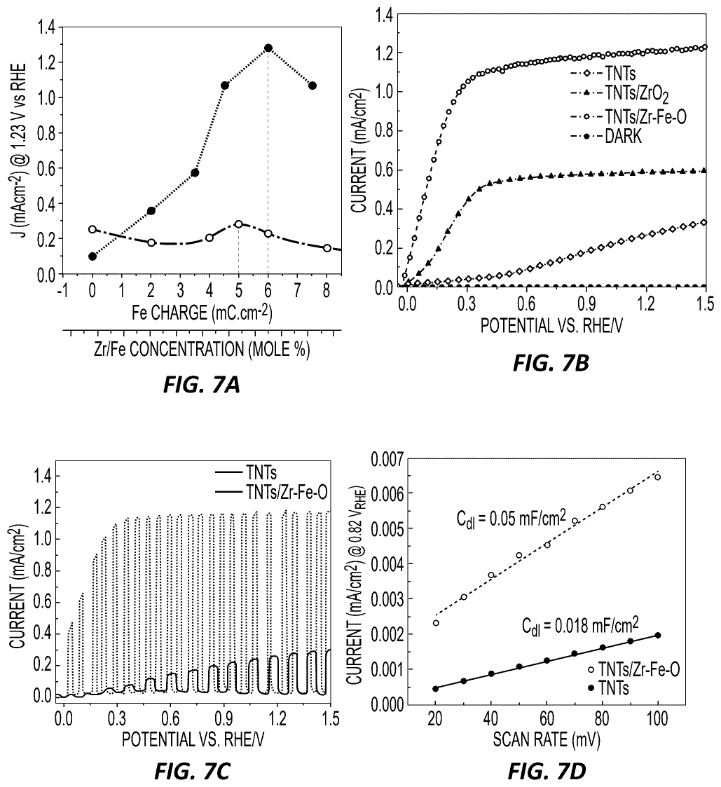

A three-electrode assembly was employed for PEC measurements in 0.1 M PBS (pH 7.5) under constant and chopped illumination conditions. Initially, the conditions for electrochemical deposition of the Fe₂O₃ particles were enhanced by varying the total charge applied for Fe₂O₃ decoration (0-10 mCcm⁻²) (FIG. 7A). The optimal charge density for total charge deposition of Fe at the superior PEC response was 5 mC cm⁻². The most optimized conditions were attained for 3.5 mole % Zr. Further, this concentration was denoted as the Zr/Fe molar ratio introduced to the electrochemical deposition bath.

The distinctive photocurrent-potential (J-V) curves for the solar-assisted water oxidation in FIG. 7B show that the optimal TNTs/ZrO₂/Fe₂O₃ films demonstrated boosted photocurrent response compared with TNTs/ZrO₂, TNTs/Fe₂O₃, and bare TNTs. The photocurrent response upsurged considerably with the bias voltage and reached ˜1.21 mA cm⁻² at 1.23 V_{RHE}, which agrees with a nearly 4.5-fold enrichment related to the bare electrodes. The photocurrent onset potentials (Vₒₙ) for all of the electrodes were determined from the quasi-steady-state J-V curves acquired at photocurrents of 0.1 mA cm⁻², and the acquired data were 0.0037 V_{R}HE for TNTs/Zr-Fe₂O₃, 0.08 V for TNTs/ZrO₂ and 0.63 V_{R}HE for TNTs (FIG. 7B).

Further FIG. 7C summarizes the J-V plots for the TNTs/Zr—Fe₂O₃, TNTs/Fe₂O₃, TNTs/ZrO₂, and TNTs photoanodes under chopped irradiation conditions of 100 mW·cm⁻². The electrode's comparative electrochemical surface area (ECSA) was determined by the capacitive measurements from the cyclic voltammetry (CV). CVs performed at various scan rates in the 10-100 mV/s. Notably, the ECSA was determined by evaluating the capacitive current associated with double-layer charging from the scan rate conditions of measurements. The double-layer capacitance (C_{dl}) was evaluated from the relationship between ΔJ=(Jₐ−J_{c}) of RHE at 0.82 V_{R}HE and the sweep rate.

Notably, the linear slope of the TNTs/Zr—Fe—O film is nearly three-fold that of the TNTs electrode, which validates that incorporating Zr—Fe—O increases the specific surface area and develops more active sites (FIG. 7D).

A substantial photocurrent response was obtained in the lower bias area (0.6 V_{RHE}) with all electrodes, as seen in FIG. 7E. This examination has clarified that the creation of the Zr—Fe—O heterojunction is the main aspect instigating the enrichment of the performance toward solar-driven water oxidation reaction.

FIG. 7F discloses the curves of the ABPE efficiency with respect to the applied bias. Notably, the pure TNTs show an ABPE of 0.083% at ˜0.77 V_{R}HE. In particular, the acquired TNTs/Zr—Fe—O films demonstrated the maximum ABPE of 0.98% at a lower potential of ˜0.29 V_{R}HE. Besides, >10 times boosted ABPE at a lower bias, directly shows that the incorporation of Zr—Fe—O over TNTs is a way to enhance the PEC nature of TiO₂. As discussed earlier, the continual charge separation and transfer method of Zr—Fe—O are vital features for the boosted PEC nature of TNTs/Zr—Fe—O electrodes.

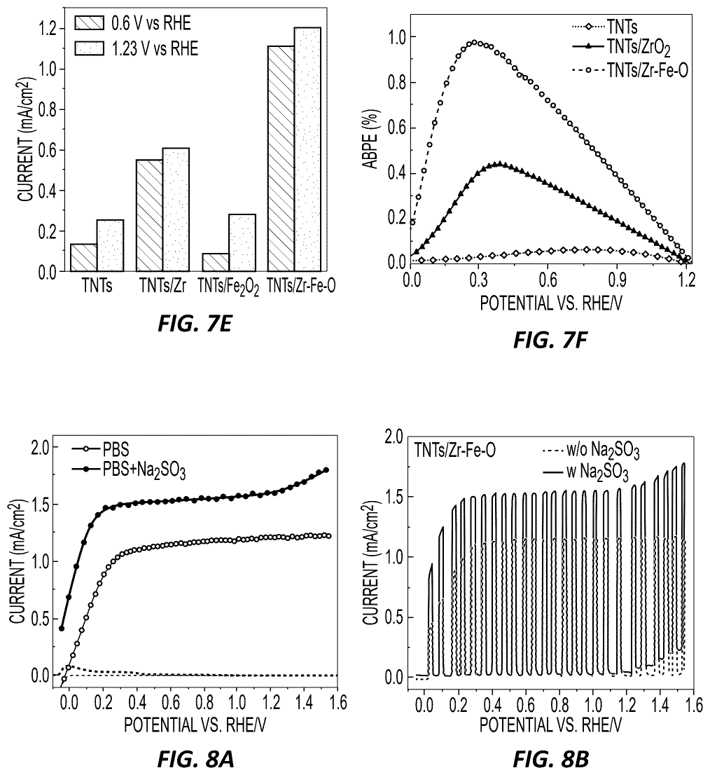

To better assess the charge transfer efficiency (η_{surface}) of Zr—Fe—O over the TNTs surface recombination, Na₂SO₃ was introduced as a hole scavenger (HS) to ignore the injection barrier for holes. Notably, both the pure TNTs and TNTs/Zr—Fe—O films display superior photocurrent response (FIG. 8A) in Na₂SO₃, credited to sulfite oxidation. Further, FIG. 8B curves exhibited the photocurrent obtained by the TNTs/Zr—Fe—O electrode under chopped illuminations with and without HS. Likewise, it evidently displays that the fabricated TNTs/Zr—Fe—O films revealed an obvious rise of photocurrent response and substantial shifts in Vₒₙ in the HS, suggesting that Na₂SO₃ eradicated the surface recombination of carriers and enhanced the injection of holes to the electrolyte than bare TNTs.

Further, to determine the charge transfer dynamics, η_{surface} of TNTs and TNTs/Zr—Fe—O at varied potentials are presented in FIG. 8C. Undeniably, independent TNTs electrodes produce only <32% η_{surface}, even at higher bias, at which the greater electric field hampers surface recombination of carriers. After including Zr—Fe—O, η_{surface} efficiency of the TNTs/Zr—Fe—O films is improved to ˜76% at 1.23 V_{RHE}, demonstrating improved charge transfer kinetics.

For further analysis, it is expected that the photoinduced holes might be rapidly and selectively trapped by H₂O₂ in an aqueous medium, which creates the developed PEC technique built on TNTs/Zr—Fe—O to be appropriate for the determination of H₂O₂. In particular, the chronoamperometric plots of TNTs/Zr—Fe—O electrode under chopped light conditions in 0.1 M PBS, and 0.1 M PBS+different concentrations of H₂O₂ (0 mM⁻¹ mM) were logged, respectively (FIG. 8D). Particularly, was shown by the anodic spikes irrespective of the chosen electrolytes. Further, the observed rapid photocurrent when the light was switched on is a degree of the flux of holes over the surface. Particularly, the photocurrent response for these anodic spikes was upsurged with the increased concentration of H₂O₂. More importantly, the observed spikes are credited to the enhanced adsorption of H₂O₂ over the electrode surface, which initiated many more photoinduced holes to be trapped. Notably, the intensity of the upsurged photocurrent shows a linear reliance on the concentration of H₂O₂.

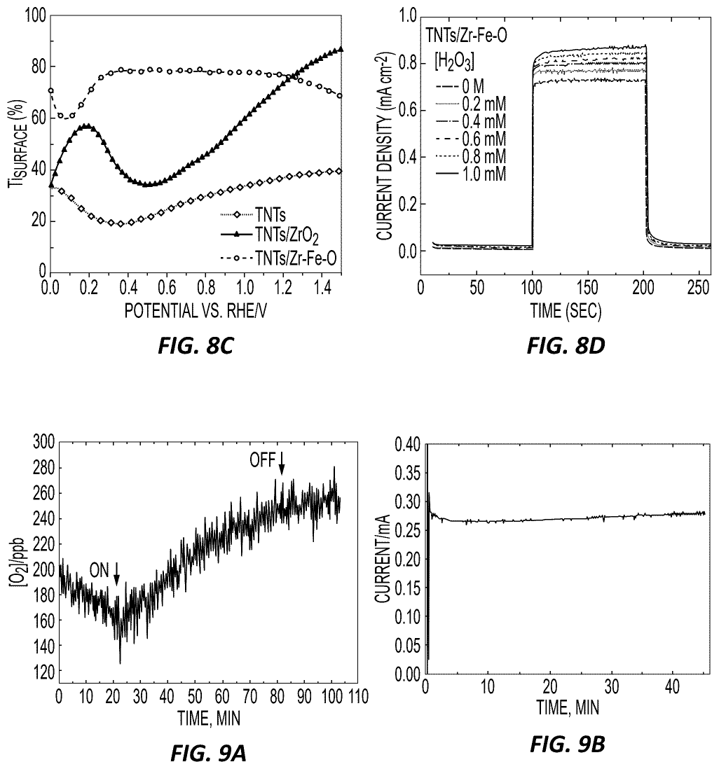

PEC generation of oxygen production via photoelectrocatalysis at TiO₂/Zr—Fe—O electrodes was detected via an Oxysense instrument. Notably, FIG. 9A evidences the oxygen evolution concentration with respect to the time for TiO₂/Zr—Fe—O films at 0.6 V_{RHE} and with continual illumination conditions. After Zr—Fe—O decoration, visible-light excitons (λ>420 nm) demonstrated dioxygen generation over the electrode surface, and their corresponding photocurrent measurements are shown in FIG. 9B. With the assistance of applied bias (0.6 V_{RHE}), dioxygen evolution was detected, and their respective concentrations were anticipated to surge linearly with applied time durations. Besides, the developed TiO₂/Zr—Fe—O electrodes demonstrated substantial durability towards incessant irradiation conditions (FIG. 9B).

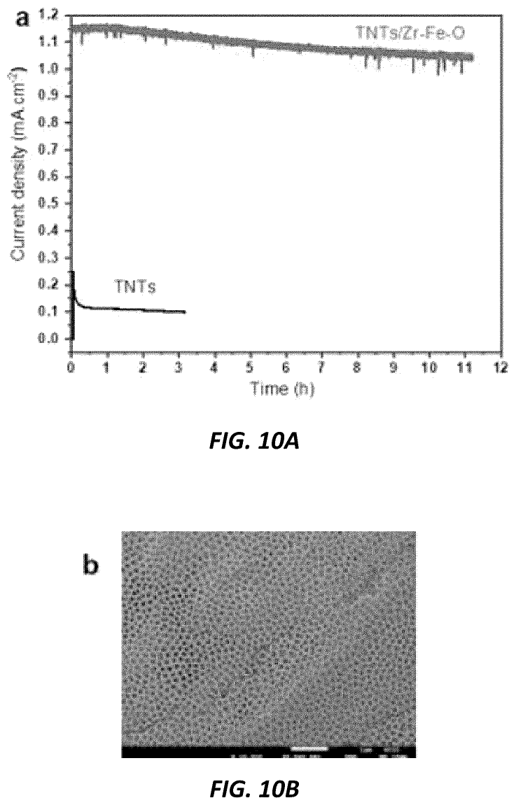

FIG. 10 presents the chronoamperometric curves under continuous illumination of TNTs/Zr—Fe—O at 1.23 V vs. RHE assessed in 0.1 M PBS (pH 7.5), with a photocurrent response of ˜1.15 mA cm⁻²; there was no observable decay, validating the remarkable long-lasting durability. However, the photocurrent response of pure TNTs decayed from 0.20 mA/cm² to 0.11 mA/cm² after continuous irradiation for 2.5 hours, because the independent TNTs were partly decayed by photoinduced holes from TiO₂ through illuminations and falling off from the TNTs surface. Meanwhile, the anodic transients witnessed in the bare TNTs photoanodes after switching the light on are suppressed for TNTs/Zr—Fe—O photoanodes, signifying a substantial reduction of surface recombination. The X-ray diffraction patterns and FE-SEM photograph of TNTs/Zr—Fe—O photoanodes were acquired at 3 hours to inspect the mass loss of TNTs through the J-t measurement. The XRD pattern and FESEM image of TNTs/Zr—Fe—O acquired at 11 hours exhibited no obvious decays associated with photoanodes obtained before 11 hours (FIGS. 10B and 10C).

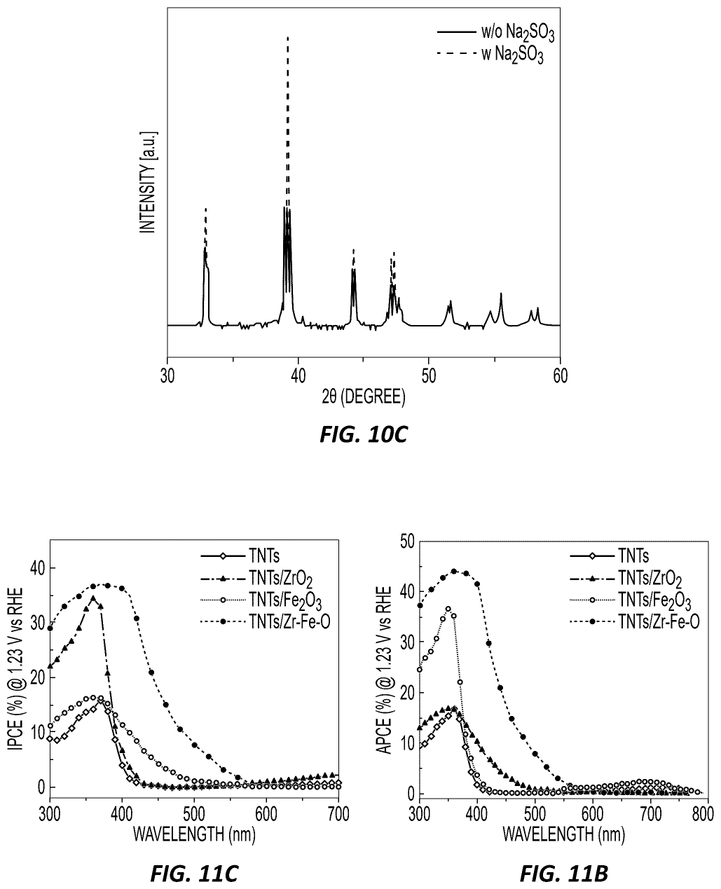

Due to Zr—Fe—O decoration over TNTs surfaces, which causes different colors, more evaluation of its wavelength-dependent PEC features was mandatory to identify the interaction between the photocatalytic behavior and light absorption of these electrodes. FIGS. 11A-11B show the comparative IPCE and ACPE data of the fabricated electrodes. The IPCE of TNTs/Zr—Fe—O was compared with that of TNTs/Zr, TNTs/Fe₂O₃, and pure TNTs at 1.23 V using a monochromator (FIG. 10A). Notably, the IPCE and APCE parameters were superior for the TNTs/Zr—Fe—O films than those of the bare TNTs photoelectrode (FIGS. 11A-11B). The onset of the IPCE was at 582 and 430 nm for the TNTs/Zr—Fe—O and TNTs films, individually. More importantly, there is an exceptional relationship between the onset wavelength of the IPCE and the absorbance analysis. A higher IPCE of 37% is measured for the optimal TNTs/Zr—Fe—O films, which is an approximately 3-time enhancement compared to the bare TNTs values. Further, the boosted PEC features for the best-performed composite electrodes can be attributed to the “cooperative” catalytic features of both ZrO₂ and α-Fe₂O₃ nanoparticles decorated over the TNTs electrodes.

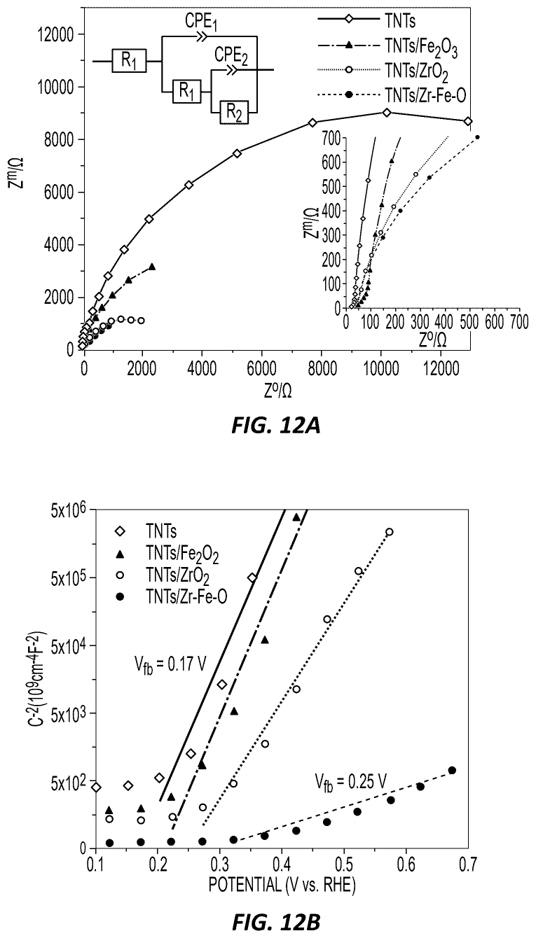

The improved charge transfer of prepared electrodes was examined by electrochemical impedance spectroscopy (EIS), as displayed in FIG. 12. The Nyquist curves of the TNTs/Zr—Fe—O films evaluated under light conditions (100 mW cm⁻²) at 0.6 V_{RHE} and their equivalent circuit are displayed in FIG. 12. Clearly, the diameter of the arc radius on the Nyquist plot of TNTs/Zr—Fe—O films is much less than those of the bare TNTs and TNTs/ZrO₂ films, denoting a fast interfacial charge transfer and separation of photoinduced charge carriers.

As seen from FIG. 12A, the radius of the arc of the Nyquist curve of TNTs/Zr—Fe—O photoanodes is relatively smaller than those of other developed electrodes, suggesting fast interfacial charge transfer and more effective charge separation of the photogenerated carriers. This can be credited to the increased substantial quantity of PEC active regions produced by the Zr—Fe—O-doped film's higher surface area. Table 1 below shows electrochemical impedance parameters obtained from the fitting to the equivalent circuit for EIS spectra studied under irradiation conditions at 1.0 V_{R}HE. Rₛ=solution resistance, R₁=charge-transfer resistance. Notably, Zr—Fe—O-incorporation boosted both the carrier density and electrical conductivity, thereby depressing the resistance (Table 1).

The decline in the R_{CT} at identical potentials strongly submits that Zr—Fe—O executes as an effective electrocatalytic candidate, enhancing the charge transfer kinetics and decreasing surface recombination. In this regard, the Zr—Fe—O incorporation enriched PEC behavior by enhancing the charge separation as well as the water-oxidation reaction over the TNTs electrode surface, which is similar to the earlier stated features of TiO₂/Fe₂O₃, and BiVO₄/Fe₂O₃.

TABLE 1
Electrochemical impedance parameters

| Electrodes | Rₛ (Ω) | R₁ (Ω) | CPE1 | n | CPE2 | n | R₂ (Ω) |
|---|---|---|---|---|---|---|---|
| TNTs | 78.88 | 14941 | 2.29E−06 | 0.92 | 6.37E−05 | 0.48 | 17585 |
| TNTs/Fe₂O₃ | 37.99 | 47.98 | 8.10E−05 | 0.65 | 0.000439 | 0.88 | 8593 |
| TNTs/ZrO₂ | 32.22 | 45 | 0.0005 | 0.62 | 0.00021 | 1.07 | 4014 |
| TNTs/Zr—O | 42.88 | 44.59 | 0.000816 | 0.55 | 0.001248 | 0.96 | 4113 |

Further, to gain more detailed information on the heterojunction ZrO₂/Fe₂O₃ films over the electrical performances of TNTs, Mott-Schottky (M-S) measurements were assessed to evaluate the charge carrier density of the films. Capacitance analysis was performed to obtain M-S plots (FIG. 12B) at every potential with a 10 kHz frequency. The obtained results of the measurements are tabulated in Table 2. They all have positive slopes, showing that TNTs electrode are n-type materials with electrons as the majority of charge carriers. Especially, the TNTs/Zr—Fe—O films show lesser slope associated with TNTs, validating enhanced carried densities after Zr—Fe—O decoration over TNTs. The Vat is anodically moved with Zr—Fe—O addition over TNTs (FIG. 12B), and the obtained results match with the anodic shift of the Vₒₙ for the optimum combination in FIG. 7B, owing to the superior thermodynamic driving force for water splitting schemes as a result of the hole accumulation at the electrode surface.

Further, promoted PEC water-splitting features was observed as a result of the synergetic influence of optimal Zr and Fe₂O₃ introduction. The estimated donor densities (Nd) of TNTs and TNTs/Zr—Fe—O were estimated to be 0.195×10²² cm³ and 2.46×10²² cm⁻³, correspondingly (FIG. 12B, Table 2). Further, the cooperative effect of Zr—Fe—O incorporation into TNTs films is an active technique to enhance the electrical conducting features of TNTs by boosting their Nd. Also, the enhancement of donor density is credited to improved photoinduced carriers.

TABLE 2
Donor densities (N_{d}) and flat band potentials
(V_{fb}) (obtained from MS plots in FIG. 12B)

| Electrodes | Nd (cm⁻³) | Vfb (V) |
|---|---|---|
| TNTs | 1.950 × 10²¹ | 0.17 |
| TNTs/Fe₂O₃ | 1.952 × 10²¹ | 0.201 |
| TNTs/ZrO₂ | 2.93 × 10²¹ | 0.25 |
| TNTs/Zr—Fe—O | 2.46 × 10²¹ | 0.249 |

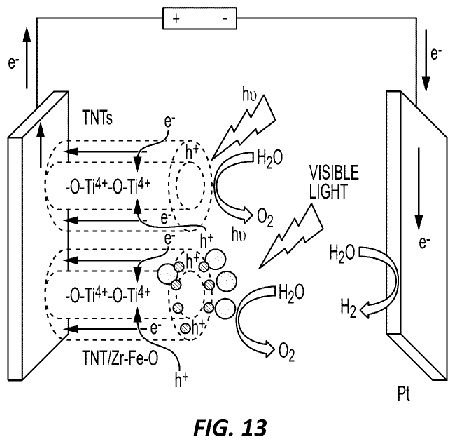

A feasible PEC water oxidation mechanism of TNTs/Zr—Fe—O is shown in FIG. 13. As shown, Zr—Fe—O films are disposed over the surface of and inside TNTs. Meanwhile, the TNTs/ZrO₂ interface supports electron trapping over Zr⁴⁺ rather than on Ti⁴⁺ resulting in decreased surface recombination and successively evolving charge transfer kinetics and, thereby, PEC characteristics for water oxidation. Furthermore, PEC performance is improved by Fe₂O₃ species. Moreover, after decorating the surface of TNTs with ZrO₂ and Fe₂O₃, photoinduced holes can be rapidly trapped by Fe₂O₃ to oxidize OH⁻ to O₂. The electrons can reach the Pt to reduce water under the externally applied bias. Also, the Mott-Schottky results exhibited a substantial change after ZrO₂/Fe₂O₃ decoration over TNTs, thus increasing the charge separation efficiencies considerably. Compared with the bare TNTs, more photoinduced carriers can be separated on the Zr—Fe—O/TNTs, prolonging the life of these photogenerated charges. Consequently, more active species can be generated by the TNTs/Zr—Fe—O to improve photocatalytic activity. Benefiting from the Zr—Fe—O incorporation, in this beneficial situation, charge carriers are well-separated and have adequate time for water oxidation which improves the PEC characteristics of the TNTs/Zr—Fe—O compared to bare-TNTs electrodes.

It is to be understood that the TiO₂ photoanodes doped with Zr—Fe₂O₃ are not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A photoanode, comprising:
a titanium substrate having TiO₂ nanotubes (TNTs) uniformly distributed thereon, the TiO₂ nanotubes being doped with ZrO₂ and Fe₂O₃;
wherein the TiO₂ nanotubes comprise pure anatase phase TiO₂.

2. The photoanode of claim 1, wherein an inner diameter of the TiO₂ nanotubes ranges from about 42 nm to about 52 nm.

3. The photoanode of claim 1, wherein a wall thickness of the TiO₂ nanotubes ranges from about 32 nm to about 46 nm.

4. The photoanode of claim 1, wherein a photoconversion efficiency of the photoanode is about 1.2 mA/cm².

5. The photoanode of claim 1, wherein a tube length of the TiO₂ nanotube is about 1 m.

6. A method of making the photoanode of claim 1, comprising:
providing titanium nanotube arrays on a titanium substrate; and
doping the titanium nanotubes with zirconium oxide (ZrO₂) and iron oxide (FeO₃) films using electrochemical deposition to provide the photoanode.

7. The method of claim 6, wherein the titanium nanotube arrays are provided on the titanium substrate by subjecting the titanium substrate to two rounds of electrochemical anodization.

8. The method of claim 6, wherein the electrochemical deposition comprises using an electroplating solution including ZrCl₂O·8H₂O and FeCl₂ for doping the titanium nanotubes.

9. The method of claim 8, wherein the electroplating solution contains about 20 mM FeCl₂ and an amount of ZrCl₂O·8H₂O in a Zr/Fe molar ratio of about 1.5% to about 6.5%.

10. The method of claim 9, wherein a Zr/Fe molar ratio in the electroplating solution is about 3.5%.

11. A photoanode, comprising:
a titanium substrate having TiO₂ nanotubes (TNTs) uniformly distributed thereon, the TiO₂ nanotubes being doped with ZrO₂ and Fe₂O₃, wherein an inner diameter of the TiO₂ nanotubes ranges from about 42 nm to about 52 nm; and
wherein the TiO₂ nanotubes comprise pure anatase phase TiO₂.

12. The photoanode of claim 11, wherein a wall thickness of the TiO₂ nanotubes ranges from about 32 nm to about 46 nm.

13. A photoelectrochemical (PEC) water oxidation system comprising the photoanode of claim 1.

14. The photochemical (PEC) water oxidation system of claim 13, wherein the photoanode achieves a photoconversion efficiency of about 1.2 mA/cm²
